(19) United States
(12) Patent Application Publication
(10) Pub. No.: US 2011/0189644 A1
(43) Pub. Date: Aug. 4, 2011

(54) Self-Correcting Learning Tray With Inserted Cards

(75) Inventors: Duncan Milne, Auckland (NZ); Anna Kirschberg, Auckland (NZ)

(73) Assignee: Duncan Milne, Huntington Beach, CA (US)

(21) Appl. No.: 13/015,803

(22) Filed: Jan. 28, 2011

Related U.S. Application Data
(60) Provisional application No. 61/299,942, filed on Jan. 30, 2010.

(51) Int. Cl. G09B 3/00

(52) U.S. Cl. 434/327

(57) ABSTRACT

A self-correcting learning tray is described comprising a see-through base and lid. Cards are inserted into the base to underlay the answer cells with the answer possibilities for the activity. There are two shapes of cards. One shape enables the card to also underlay the base as well as the lid. The other shape enables the card to sit under the answer cells of the base with the remainder protruding outside of the coverage area of the tray. Each card is printed with a unique pattern on the reverse side. Each tile has a component of that pattern printed on it. The answer is revealed by turning the tray over and sliding out the card, where the answer printed on the card should match the answer comprised by the tiles in the base of the tray.

### CROSS-REFERENCE TO RELATED APPLICATIONS

Not Applicable.

### STATEMENT REGARDING FEDERALLY SPONSORED RESEARCH AND DEVELOPMENT

Not Applicable.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### FIELD OF THE INVENTION

This invention relates to a learning device requiring the matching of tiles to answers that are under-laid on cards within this device.

### DISCUSSION OF RELATED ART

Self-correcting devices are often used for teaching children as they enable the child to work independently. Children can check their own making mistakes and learn what the correct answer is with these devices.

U.S. Pat. No 4,634,385 discloses a self-correcting device used for teaching a child's ability in various arithmetic concepts. The device consists of a problem disk, an answer disk and a frame. The answer disk has a larger diameter than the problem disk allowing children an opportunity to move either the question or the answer into the correct position. From here the child will know if she has completed the question correctly as the color-coding between question and answer will agree.

Another form of self-correcting device is a self-correcting tray. Self-correcting trays are an enclosed tray with anywhere from 6 to 24 tiles depending on the size of the tray. Each tile and answer tray is coded with numbers, letters and/or other indicia. Children are asked to move these tiles from one side of the tray to the other whilst completing various learning based tasks (such as math or reading) where the answer represents a number or letter that corresponds to the correct tile and its correct place in the tray. The tray is then turned upside down to represent an answer pattern on the back which is then compared with the answer pattern printed in the book. The child then becomes aware if they are correct based on matching the pattern which enables the tray to be used independently of the teacher in a self correcting manner.

One limitation of self-correcting trays is that they can become confusing as they require the user to match numbers or letters from a question sheet to an answer tray, whilst carrying the correct answer in the user's working memory. More recently, self-correcting trays have evolved to see-through forms on both the question and answer side of the tray to facilitate question to answer matching. The limitation of see-through self-correcting trays is that they can no longer be used for question and answer type activities as the question is too large to fit in a square that is used for the matching example.

A second limitation of current self-correcting trays devices is that the answering pattern is represented in books in a miniature form. Further confusion arises when the tray is turned over to see the answer pattern. This is because depending on the orientation of the tray will depend if the answer matches correctly.

Therefore, there is a need for a device that combines the benefits of matching and question/answer into one tray, whilst taking advantage of a transparent answering system (so that children are not confused by two numbers when matching their answers). Furthermore, there is also a need for a simpler answering system where children can clearly see whether they have the answer right or wrong. The present invention accomplishes these objectives.

### SUMMARY OF THE INVENTION

The present invention (“the invention”) is a self correcting tile tray comprising of a transparent hinged lid and an open cell base. A unique feature of this tray is the trapezium shape that enables a purpose built card to slide in behind the tray. There are two types of card that have been designed for use with the tray: 1) a matching card; 2) a detailed question/answer card.

Both cards share the trapezium shape for their respective answer section.

First use, for the matching card, all tiles are placed on the transparent lid in the order of one through to 10 and this is guided by a small number printed in the top corner of the question side of the card. From here, the child lifts the first tile (marked 1), sees the image (e.g. cat) and then completes the activity (e.g. matching to an image that rhymes) by placing the tile over the corresponding image (e.g. bat) represented on the answer side of the card showing below the open 10 cell base.

Second use, for the detailed question and answer card, all tiles can be placed on the transparent lid (to keep them in order) or just placed on the table. To begin the activity the children reads the first question (e.g. 1 tile: I took the to school) and then places the 1 tile over the answer in the 10 cell base.

Answers are revealed by turning over the tray and sliding out the card. The answer pattern represented on the reverse side of the card will represent the pattern formed on the reverse of the tiles when the activity has been answered correctly.

The present invention is a device that combines the benefits of a traditional learning tray that has two transparent (or open) sides, and a card that inserts under the tray with feeding tabs and runners. The tray in the present invention provides two different activities and ways of completing those activities depending on the card used. Other unique features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a perspective view of a first embodiment of a tray of the present invention, illustrating the transparent lid, base with 10 cells, feeding tabs, runners and tiles.

FIG. 2 is a perspective view of a matching card which is used for matching activities with the tray.

FIG. 3 is a perspective view of a detailed question and answer card which is used for detailed question and answer activities with the tray.

FIG. 4 is a perspective view of a set of 10 tiles.

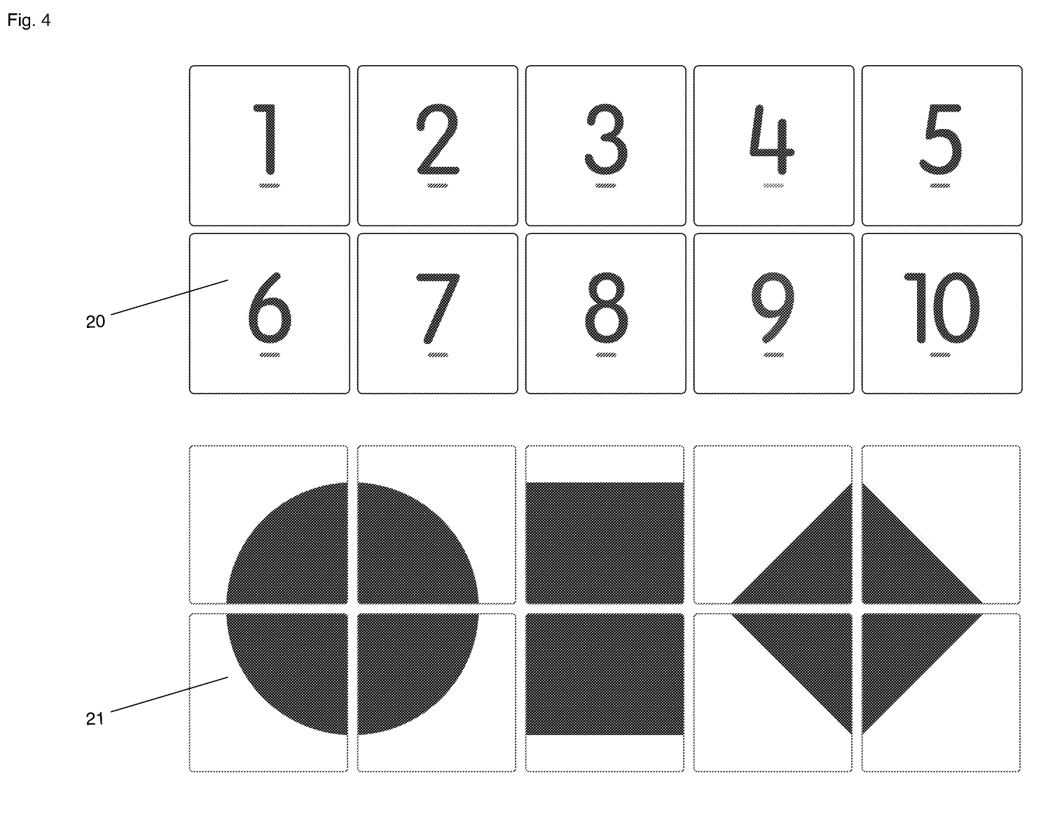

### DETAILED DESCRIPTION OF THE PREFERRED EMBODIMENT

Illustrative embodiments of the invention are described below. The following explanation provides specific details for a thorough understanding of and enabling description for these embodiments. One skilled in the art will understand that the invention may be practiced without such details. In other instances, well-known structures and functions have not been shown or described in detail to avoid unnecessarily obscuring the description of the embodiments.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

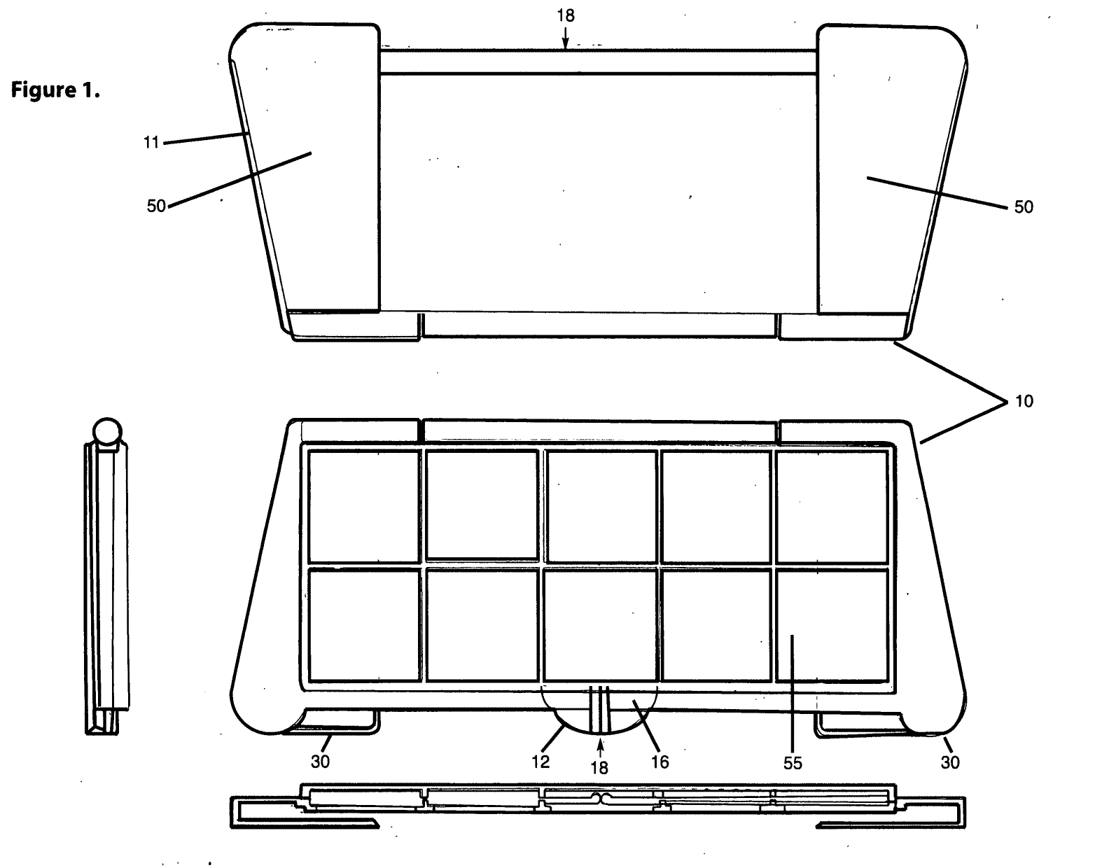

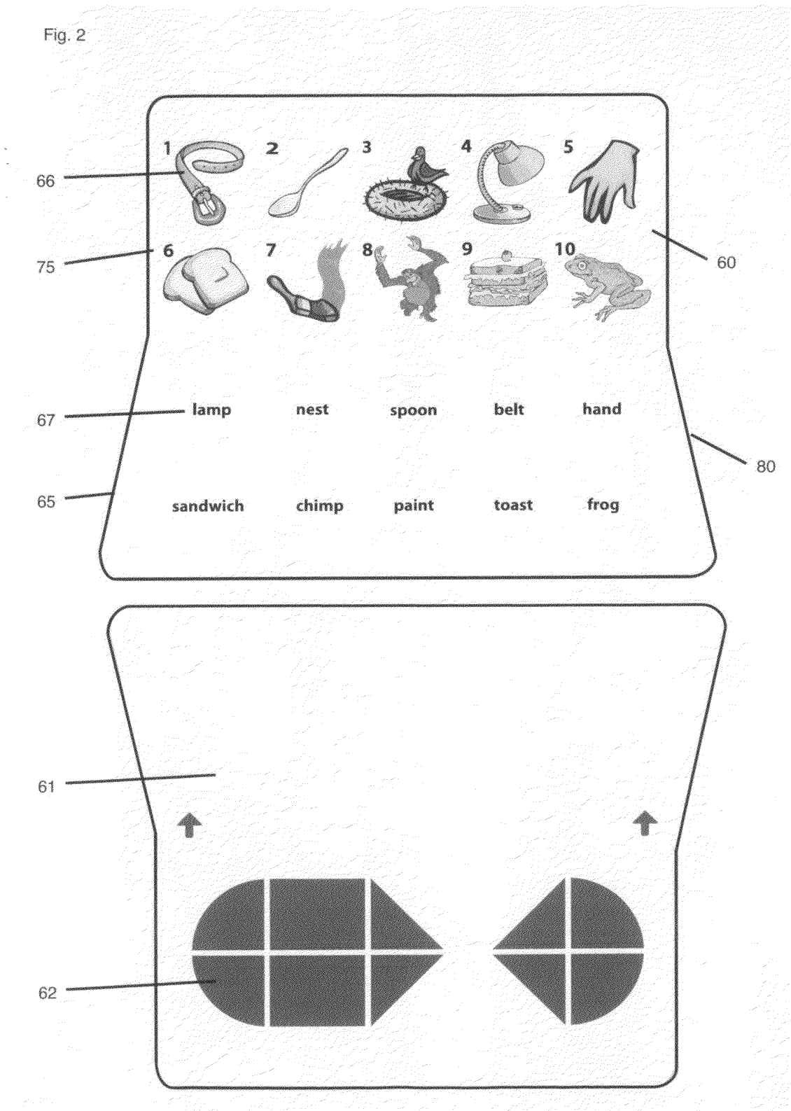

FIG. 1 illustrates the tray 10. FIG. 2 illustrates the ten tiles 20 designed to work with the tray 10. The card fits under the tray supported by the feeding tabs 30 and runners 50. In such an embodiment, each component is preferably made from plastic with the lid 15 made from transparent plastic. The lid is equipped with a closing tab 16 which forms a closing tab with the base tray in the centre 12.

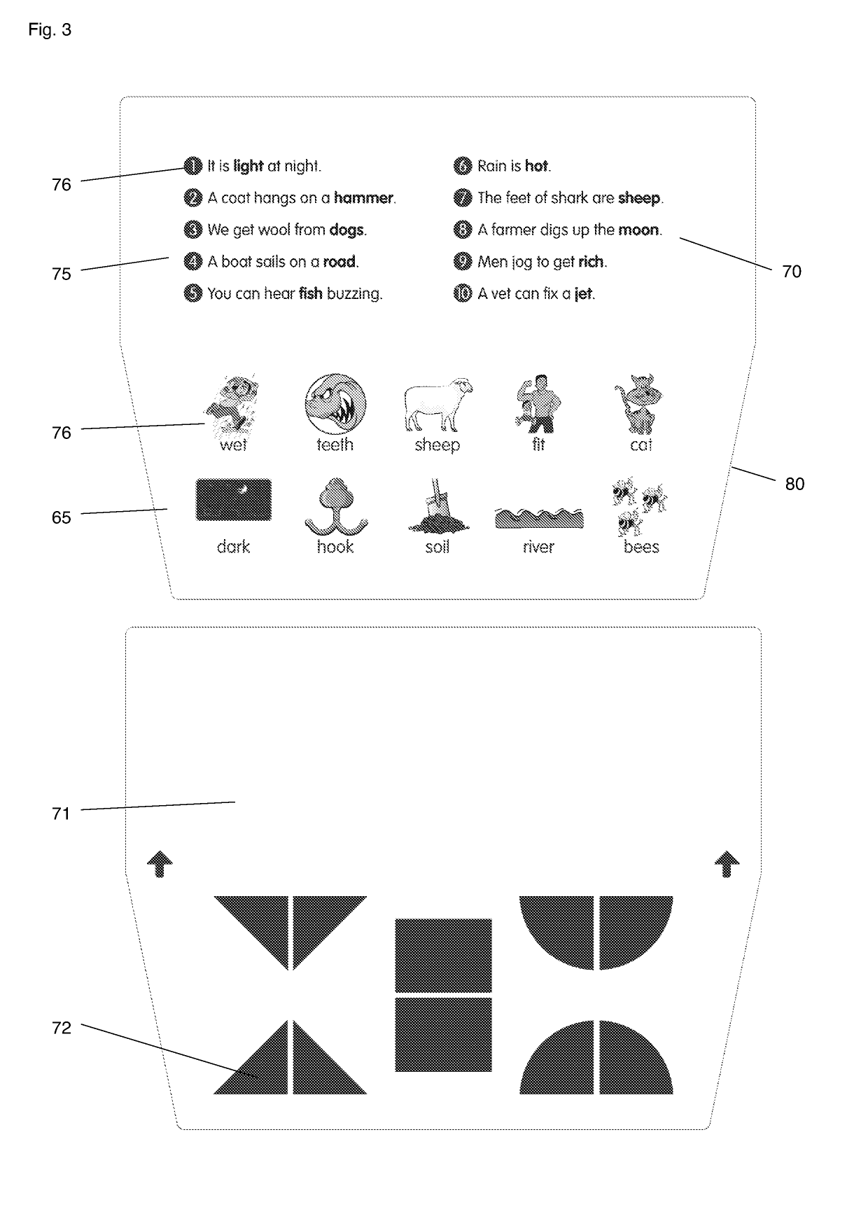

Each cell in the base of the tray is used for representing an answer square 55. FIGS. 2 and 3 show the matching 60 and detailed question/answer 70 cards that can be used in the tray. Each card has an angle form 80 to ensure the card fits into the tray in the correct direction. On each card there are two sections—an answer section 65 and a question section 75. The matching card comprised of 10 question squares 66 and 10 answer squares 67. The detailed question/answer card comprises of a question section containing 10 questions 76 and ten answer squares 77 in the answer section 65.

In use, the player takes a question card 60 or 70 and inserts this card into the tray 10 by placing the card on the feeding tabs 30 and by pushing the card into the device it will naturally run into the device due to the runners 50 and stop in the correct position due to the angled shape on the side of the cards 80 and the runners 50.

Both types of cards are inserted in this way 18, however, while the matching card 20 sits under the transparent lid 15 and the tray base 10, the detailed question/answer card 30 only sits under the tray base 10. The remainder of this card sits outside of the tray 12 with the transparent lid 15 opening the other way. Here, the transparent part of the tray can be used for storage of the tiles before beginning and/or completing the activity but it does not have to. The matching task involves taking a tile from the answer (upper) section of the tray 15 and placing it over the appropriate answer in the bottom part of the tray (the base tray 10). The detailed question/answer card task involves taking a tile from the table (or stored in the transparent part of the lid 15), and placing it over the correct answer in the base tray 10.

The self-correcting system involves turning over the tray so that the reverse side of the tray 11 is facing upwards along with the card 61 or 71. From here the card 60 or 70 is pulled out of the tray 10 so that the answer pattern 62 or 72 is the same as what is revealed on the reverse of the tiles 21.

While a particular form of the invention has been illustrated and described, it will be apparent that various modifications can be made without departing from the spirit and scope of the invention. For example, math questions and answers are illustrated in the figures. However, questions and answers on any subject could be included. Accordingly, it is not intended that the invention be limited, except as by the appended claims.

The teachings provided herein can be applied to other systems, not necessarily the system described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

These and other changes can be made to the invention in light of the above Detailed Description. While the above description details certain embodiments of the invention and describes the best mode contemplated, no matter how detailed the above appears in text, the invention can be practiced in many ways. Details of the system may vary considerably in its implementation details, while still being encompassed by the invention disclosed herein. Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms.

Accordingly, the actual scope of the invention encompasses not only the disclosed embodiments, but also all equivalent ways of practicing or implementing the invention. The above detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

Changes can be made to the invention in light of the above “Detailed Description.”

While the above description details certain embodiments of the invention and describes the best mode contemplated, no matter how detailed the above appears in text, the invention can be practiced in many ways. Therefore, implementation details may vary considerably while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated.

In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

What is claimed is:

1. A self-correcting learning tray comprising of a see-through lid and base of which a question/answer card can be inserted so that it sits under the answer cells of the base tray and where tiles are used to overlay the answer cell with the correct answer.

2. A self-correcting learning tray of claim 1 wherein the question/answer cards are two shapes; 1) to slide completely under the tray resting under the base and transparent lid; or 2) to slide into the base with printed matter remaining outside of the tray in terms of its overlay.

3. A self-correcting learning tray of claim 1 designed in a shape to accept two different types of cards with an angled form ensuring the correct direction for the two types of cards.

4. A self-correcting learning tray of claim 1 where the answers of the activity are represented on the reverse side of the question/answer cards.

5. The answer on the reverse method in claim 4 where the answer is represented as a pattern, geometric shape or coded system.

6. The answer on the reverse method in claim 4 where the answer is revealed by sliding the card out of the tray and the pattern on the reverse of card matches the pattern on the reverse side of the tiles as they are represented in the base of the tray.
